(19) United States
(12) Patent Application Publication
(10) Pub. No.: US 2008/0271699 A1
(43) Pub. Date: Nov. 6, 2008

(54) Combustion Engine

(76) Inventors: Jens Wellev, Virum (DK); Anders Elonsson, Skahamn (SE)

Correspondence Address: HARNESS, DICKEY & PIERCE, P.L.C., P.O. BOX 8910, RESTON, VA, 20195, US

(21) Appl. No.: 11/922,926

(22) PCT Filed: Jun. 27, 2006
(86) PCT No.: PCT/SE2006/000793

§ 371 Date: Dec. 27, 2007

Related U.S. Application Data
(60) Provisional application No. 60/693,774, filed on Jun. 27, 2005.

(51) Int. Cl. F02F 3/00

(52) U.S. Cl. 123/193.1

(57) ABSTRACT

The present invention relates to an internal combustion engine of piston type operating with a mixture of combustible fuel and air comprising at least one combustion chamber (11) and a piston (2) movably arranged in said combustion chamber (11) to compress the fuel and air mixture so as to provide a maximum compression ratio in the range of 15:1 to 25:1; an inlet (4) arranged in said combustion chamber for receiving an amount of said mixture of fuel and air into said combustion chamber (11); and an igniting device (3) arranged in said combustion chamber (11) for igniting said mixture of fuel and air received in said combustion chamber (11) at a crank shaft (9) angle position in the range of 0 degrees to 15 degrees after a top dead center (ATDC) of said piston in said combustion chamber (11); wherein the combustion chamber and piston is arranged to reduce the risk of hot spots and the engine is configured to have a burn rate where 90% of the fuel is burnt in a crank angle position range of between 15° to 40°. The invention also relates to a method or combustion, a vehicle, ship or power plant comprising the combustion engine according to the present invention.

### FIELD OF THE INVENTION

The invention relates to a spark ignited internal combustion engine of piston type and in particular to an engine with a combustion cycle with an ignition starting after a top dead center.

### BACKGROUND OF THE INVENTION

Combustion engines have been subjected to extensive development for the past 200 years, but the overall basic principles remain the same, with the Otto type engine being one of the most popular internal combustion engine types. The Otto type engine has a piston that compresses an air/fuel mixture inside a cylinder and when the air/fuel mixture is compressed as most at a top dead center (turning point of the piston inside the cylinder, TDC), an electrical spark ignites the mixture and the explosion increases the pressure inside the cylinder and drives the piston down from the TDC and exerts a force that may be utilized in driving a process or an object in connection to the engine, such as the drive wheels of a vehicle. Ignition cycle timing is often related to a crank shaft angle position in degrees with respect to the top dead center, where 0° is the top dead position, 180° is when the piston is at a position as far away as possible to the TDC.

The most common solution on the market today concerning the ignition timing cycle starts before the piston is at the TDC in order to reduce the risk of self ignition of the fuel due to the high compression that may be present at the TDC and to achieve maximum brake torque (MBT). These engines often have a variable ignition location with respect to the crank shaft angle, with an ignition location of 25° before the TDC for high engine revolutions and closing in towards the TDC at lower engine revolutions. This requires a complex ignition control.

In order to reduce wear on the force transmitting components in the engine a multiple cylinder engine need to have a specific ignition order with respect to the different cylinders; for instance a six cylinder engine often has a timing order of cylinder 1, 5, 3, 6, 2, and 4, meaning that cylinder 1 ignites first, cylinder 5 after cylinder 1, cylinder 3 after cylinder 5 and so on until a complete cycle has been completed. This engine design solution in turn may lead to more complex design of engines and higher production costs.

Often combustion engines run at compression ratios under 10:1 in order to reduce risk for self ignition of the air/fuel mixture inside the combustion chamber. However, a rule of thumb is that the higher the compression ratio the higher the efficiency of the engine. There is therefore a balance finding a suitable compression ratio.

A so called Lambda value is obtained in connection to exhaust measurements. The Lambda value is a measure on the efficiency of the combustion process and is governed by the initial air/fuel ratio and depending on how the engine is run different values is obtained from measurements and a value of 1 is an optimal theoretical value of Lambda with equal amounts of oxygen and fuel.

Due to the early ignition point with the normal operation of the engine some parts are subject to considerable wear which may lower the life time of the engine. It would be advantageously to have a later ignition point after the TDC in order to reduce the wear on these engine parts. However, this is counter parted by the problems of self ignition due to higher compression ratios and higher exhaust temperatures.

U.S. Pat. No. 5,487,362 disclose a converted diesel engine running on gas that utilizes a late ignition point of ca 4° after the TDC (ATDC). This solution as presented has some drawbacks in the form of risk of self ignition of air/fuel mixture due to the high compression, damage to the cylinder due to self ignition and/or high temperatures present during combustion. The engine in this solution is also only able to run on gas (LPG, Liquid Propane Gas) as fuel.

### SUMMARY OF THE INVENTION

It is the object of the present invention to remedy some of the problems described above and provide an efficient engine running on many types of fuel with small changes needed to convert the engine in different fuels.

This is provided by with an engine with a careful design of the combustion chamber in order to reduce risk of self ignition and reduce temperature and high compression effects.

A first aspect of the present invention, an internal combustion engine of piston type operating with a mixture of combustible fuel and air is provided, comprising:

at least one combustion chamber and a piston movably arranged in the combustion chamber so as to provide a maximum compression ratio in the range of 15:1 to 25:1;
an inlet arranged in the combustion chamber for receiving an amount of the mixture of fuel and air into the combustion chamber; and
an igniting device providing a spark from a voltage in excess of 25 kV arranged in the combustion chamber for igniting the mixture of fuel and air received in the combustion chamber at a crank angle position in the range of 0 degrees to 15 degrees after a top dead center (ATDC) of the piston in the combustion chamber;
wherein the combustion chamber and piston is arranged to reduce the risk of hot spots and the engine is configured to have a burn rate where 90% of the fuel is burnt in a crank angle position range of between 15° to 40°.

The compression ratio is preferably in a range between 17:1 to 20:1, and even more preferably between 17.5:1 to 18.5:1.

The crank angle is preferably in a range between 0° and 5°, and most preferably 20 after the top dead center (ATDC).

Substantially all edges of components inside the combustion chamber are rounded with a radius of at least 0.5 mm. The radius of edges is approximately 2 mm.

The ignition device comprises a spark plug in turn comprising a substantially smooth surface between a spark plug inlet in the combustion chamber and a spark generating unit on the spark plug.

The edges on the piston are rounded with a radius of at least 0.5 mm.

The combustion engine further comprising a control device with means for controlling a ratio of the fuel and air mixture, and further comprising an oxygen sensor, for instance a Lambda sensor, located after the combustion chamber in an exhaust outlet conduit, the control device may read a signal from the oxygen sensor and the signal may be used for determining the ratio of air to fuel mixture.

The control device may control a position of an adjustable air to fuel ratio controlling element

The control device may be arranged to hold a Lambda value at approximately 1.

The crank angle ignition position may be kept fixed during operation of the engine.

The crank angle may be adjustable between 10 degrees ATDC to 0 degrees ATDC depending on power output and/or revolutions.

The igniting device may comprise a spark plug operating at a voltage preferably in excess of 25 kV and even more preferably in excess of 30 kV.

The combustion engine may further comprise a turbo providing a maximum turbo pressure of 0.8 bars, and preferably 0.4 bars.

The fuel may be at least one of petrol (gasoline), alcohol (e.g. Methanol or Ethanol), LPG (Liquid Propane Gas), natural gas, bio gas, and city gas.

The combustion engine may further comprise means for controlling the ignition point with respect to crank shaft angle.

The combustion engine may further be arranged with a squish height of at least 0.7 mm. Furthermore the engine may be arranged so as to keep the inlet valve open during a portion of the compression cycle, for instance at least 10% of the compression stage.

Another aspect of the present invention, a combustion engine is provided, wherein air and fuel are mixed in a mixing device comprising:

a venturi device;
an air inlet; and
a fuel inlet structure;
wherein a position of a valve is adjustable providing an adjustment of a ratio of the air/fuel mixture.

Yet another aspect of the present invention, a method of combustion in a combustion engine, comprising the steps of:
providing a combustion engine comprising a combustion chamber with a piston, the chamber and piston both arranged to reduce hot spots;
configuring the combustion engine so as to provide a high burn rate where 90% of the fuel has burnt within a crank angle position range of 15° to 40°.
providing an air/fuel mixture to the combustion chamber through an inlet;
closing the inlet during a compression stage; and
igniting said air/fuel mixture when a maximum compression ratio of said air/fuel mixture is in a range of 15:1 to 25:1 and when a crank angle position of a piston is in a range of 0 degrees to 15 degrees after a top dead center (ATDC).

Substantially all edges inside a combustion chamber are provided with a radius of at least 0.5 mm.

In the method of controlling a combustion according, the compression ratio is preferably in the range between 17:1 to 20:1, and even more preferably between 17.5:1 to 18.5:1.

The crank angle may preferably be in a range between 0° and 5°, and most preferably 20 after the top dead center (ATDC).

The radius of edges may be approximately 2 mm.

The method further comprising:

obtaining a signal of an oxygen value after the combustion chamber;
feeding the signal to a control device; and
controlling a ratio of the air/fuel mixture provided to the combustion chamber using the signal as control value.

The control device keeps the oxygen value to approximately Lambda=1.

Still another aspect of the present invention, a vehicle, ship or power plant comprising an internal combustion engine of piston type as described above.

These and other aspects of the invention will be apparent from and elucidated with reference to the embodiments described hereinafter.

### BRIEF DESCRIPTION OF THE DRAWINGS

In the following the invention will be described in a non-limiting way and in more detail with reference to exemplary embodiments illustrated in the enclosed drawings, in which:

FIG. 1 illustrates cylinder of an engine according to the present invention;

FIG. 2 is a schematically depiction of a pressure versus crank angle according to the present invention;

FIG. 3 is a schematically depiction of a pressure versus crank angle according to the present invention;

FIG. 4 is a schematically illustration of an air/fuel mixer according to the present invention;

FIG. 5 is a schematically illustration of an engine according to the present invention; and

FIG. 6 is schematically illustration of a control device according to the present invention.

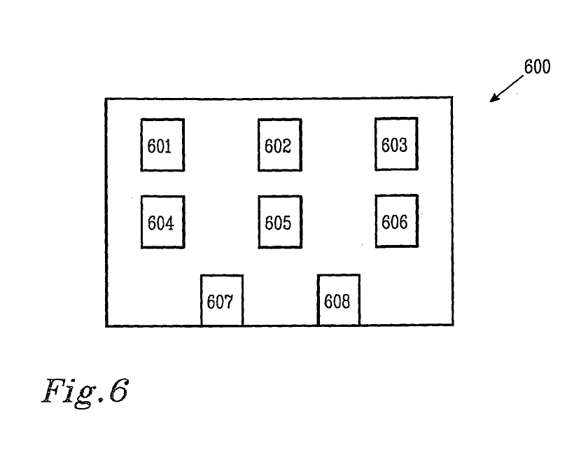

FIG. 7 is a schematic illustration of a piston with a cavity according to the present invention.

### DETAILED DESCRIPTION OF THE INVENTION

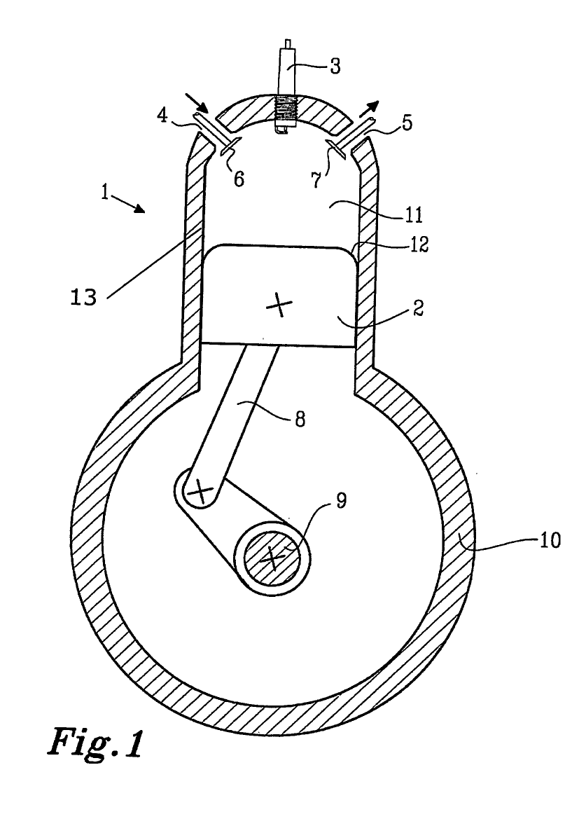

FIG. 1 illustrates a cylinder 1 in an engine with a piston 2 that is movable between two positions in the cylinder 2, compressing an air/fuel mixture injected from an inlet 4 at one position of the positions of the piston 2 in the cylinder 1 (a top dead center, TDC). A spark plug 3 (or similar ignition device) located at the TDC ignites the air/fuel mixture and the combustion of the fuel increases the pressure within the cylinder 1 driving the piston 2 away from the top position. After the combustion, resulting exhausts are ventilated out through an exhaust outlet 5. The inlet and outlet openings are controlled by a respective valve 6 and 7. The invention is not limited to 2 valves per cylinder, but any suitable number of valves may be used as understood by the person skilled in the art. The volume defined by the piston 2, an inner lining of the cylinder 13, and the top end of the cylinder (i.e. the end where the spark park plug 3 is located) is a combustion chamber 11.

The movement of the piston is in operational mechanical connection to a connection rod 8 connected to a crank shaft 9, and which in turn is in mechanical connection to other parts of a system which the engine provides power to.

The engine comprises many other parts and aspects as understood by the person skilled in the art, including, but not limited to, pumps, cooler, electrical wiring, electrical ignition system, and numerous details for the mechanical operation of the engine. Only the essential details for the understanding of the present invention are discussed within this document.

The piston is moved towards the top end of the cylinder and at the turning point (Top Dead Center—TDC) where the compression of the air/fuel mixture is at largest. In the present invention the compression ratio is in the range of 15:1 to 25:1, depending on fuel used; for LPG (Liquid Propane Gas) the range is preferably between 17:1 to 20:1, and even more preferably 17.5:1 to 18.5:1. The most suitable compression ranges will vary depending on the fuel used. The engine may operate with up to 3 to 4 times the compression as compared to conventional engines.

The ignition timing with respect to a crank shaft 9 rotational angle position, where 0° is when the piston 2 is at the TDC, is preferably kept fixed at a value between 0° and 25°, more preferably between 0° and 15°, even more preferable between 0° and 5°, and most preferably 2° after the top dead center (ATDC) of the rotational angle of the crank shaft 9. This may be dynamically changed during operation of the engine and depending on the engine revolutions and/or power output. For example, the ignition may start at 100 ATDC during start of the engine, 50 ATDC as an intermediate step, and 2° ATDC at full power. However, this type of operation of the engine according to the present invention requires complex control of ignition and delivery of the air/fuel mixture, but an even more silent engine is acquired as a bonus effect. It should be understood that ignition timing in this document is referenced to the actual spark and not to control signals initiating the spark generation since depending on ignition system different delays may be present.

A knock sensor may be used in order to better control the ignition start with respect to the crank shaft position.

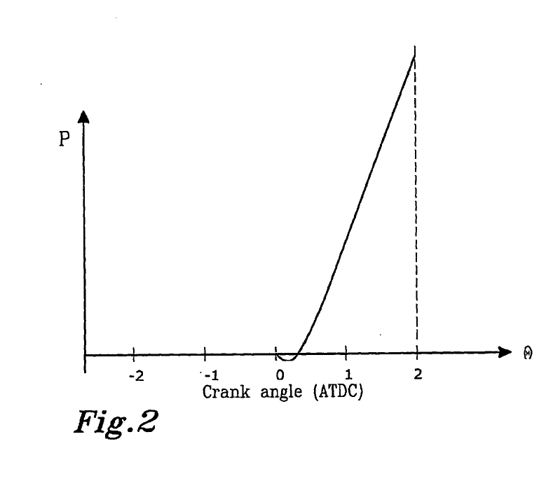

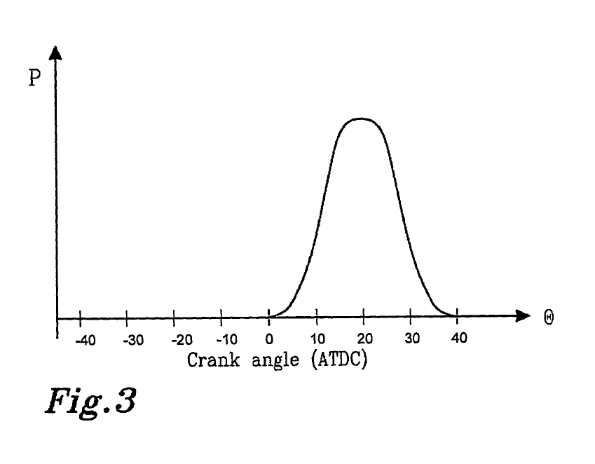

FIG. 2 shows a graph of pressure in the combustion chamber 11 versus crank angle position (with respect to TDC). In FIG. 2 the ignition starts at ca 0° ATDC. FIG. 3 illustrates a larger portion of the ignition cycle, showing that the maximum pressure is obtained at approximately 20° ATDC. This is only a conceptual illustration in order to show that rapid burning is achieved and that the maximum pressure is received at a position of the crank shaft around 20° ATDC and that the entire combustion process is ended before the crank shaft reaches the bottom dead end.

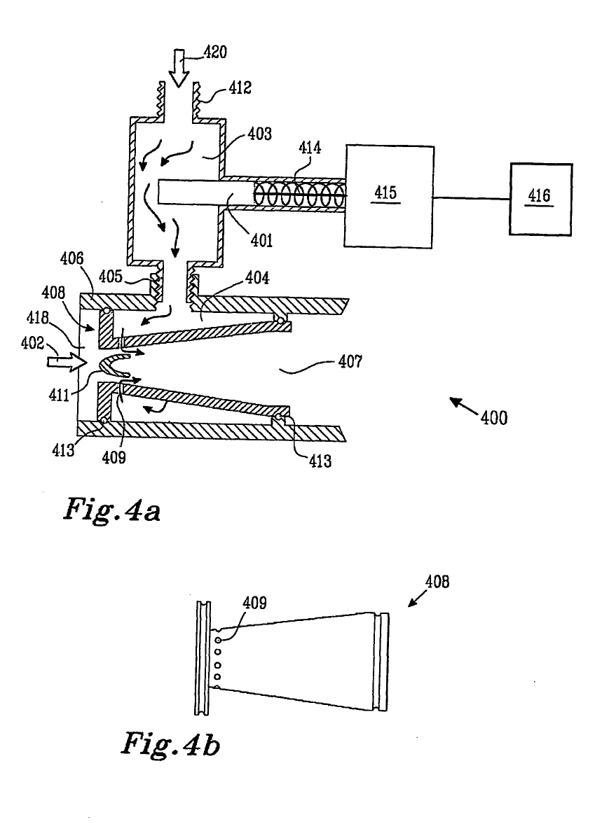

An air/fuel mixer is located prior to the inlet 4 to the cylinder 1 in order to mix an appropriate mixture of air and fuel; such a mixer may be a venturi device 400 as illustrated in FIG. 4a and FIG. 4b comprising a fuel 420 inlet 412 to a fuel flow controlling chamber 403. A valve 401 or similar device may control the flow of fuel. The valve is actuated by an actuating device (such as a stepper motor or any other suitable actuating device as understood by the person skilled in the art) 415 which in turn may be controlled by a controlling device 416. The fuel flow controlling arrangement is connected to a mixing device 406 through a connection port 405. Fuel enters into a chamber 404 in connection to a venturi device 408 comprising a mixing chamber 407 through a fuel inlet structure in the form of one or several port holes 409. Air 402 (or any other oxidizer) enters from an air inlet 418 and is forced to turbulent flow using a flow disturber 411. Air and fuel mixes in the mixing chamber 407 and continues towards the combustion chamber 11. The venturi device 408 is connected to the mixing device 406 with one or several O-rings 413 providing a fuel and/or air tight connection. The venturi device 408 is thus easily interchangeable depending on fuel to be used.

Fuel is supplied from a fuel tank via a fuel line and the fuel intake 412. The port holes 409 may be provided with different forms or structures of nozzles or holes in order to even further enhance the mixing effect. The structure, amount, and size of these nozzles or holes 409 may be different depending on fuel used in order to deliver a suitable amount of fuel, suitable spreading properties, and so on.

Depending on fuel, the fuel inlet structure 409 is different with respect to total area available, minimum area, type of structure, and equilibrium area in order to obtain a suitable basic theoretical air/fuel ratio. Therefore a second actuating device (not shown) may be provided for changing the structure of the fuel inlet 409 and/or the basic starting point of the air/fuel ratio.

In some fuel injection systems fuel is pulsed and in some the fuel is supplied in a continuous manner, in both cases it is important that the fuel does not have laminar flow but rather a turbulent flow in order to better mix with air.

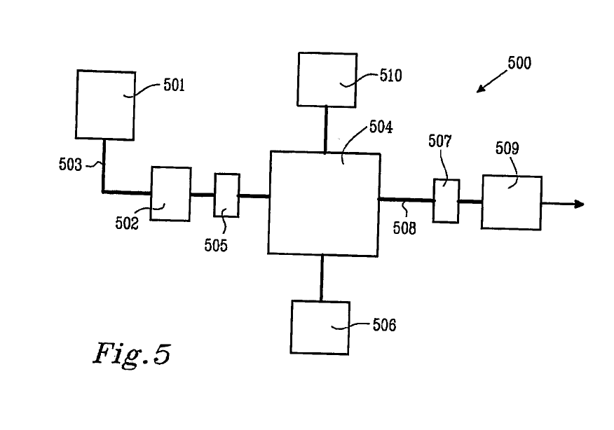

FIG. 5 is a schematic illustration of the combustion engine system 500 according to the present invention, wherein a fuel is provided from a fuel tank 501 and led to the air/fuel mixing device 502 via a fuel line 503. Air is taken into the air/fuel mixer 502 and the mixture is dispensed to the combustion system 504 using a dispensing device 505. The dispensing device 505 may be a throttle for instance controlling the amount of air/fuel mixture that is allowed to enter into the cylinder 1.

The combustion system comprises a cylinder, piston, and other mechanical parts as described in relation to FIG. 1 and provides power to a process to be powered 506. After the combustion system 504 a sensor 507 is provided in situ of an exhaust line 508 for measuring oxygen content (for obtaining a so called Lambda value, i.e. the ratio of the air/fuel mixture) of the exhausts, this will give a value of the efficiency of the combustion process. This sensor 507 may be a Lambda sensor for instance. Optionally, a catalytic converter 509 may be provided if so desired or demanded by regulatory aspects. A control device 510 may be provided for controlling the different components of the engine system 500.

The signal from the lambda sensor provide a control signal that may be used for controlling the ratio of the air/fuel mixture in order to further control the combustion efficiency of the engine with respect to power output. The signal from the sensor 507 is read into the control device 510. The control device 510 may comprise an electronic steering device 600. Such an electronic steering device 600 may comprise at least one computational device 601 (e.g. a microprocessor), memory means 602 (volatile or non-volatile), optionally at least one sensor conditioning device 603, and sensor connector 607. The electronic steering device 600 may further comprise at least one communication connection 608 for communicating with internal engine parts and/or parts in connection to the engine (such as for instance vehicle parts, such as fuel level monitor, speed of wheels, torque applied to process attached to the engine, and so on as understood by the person skilled in the art), non-volatile memory 604 for storing data, communication connection 605 for communicating with an external diagnostic system or analyzing system. Other optional devices 606 may be provided depending on application area of the engine. Communication connections 605, 607, and 608 may be of any suitable type including, but not limited to, Ethernet, CAN bus, I2C bus, MOST bus, Intellibus, and so on, as well as wireless communication systems (e.g. wireless local area networks (e.g. 802.11 based wireless systems), wireless personal area networks (e.g. Bluetooth), and so on).

The control device 510 controls the air/fuel ratio by for instance steering the actuating device (not shown), e.g. stepper motor, controlling the location of the valve 401 thus providing control of the amount of fuel transferred through the fuel flow controlling chamber 403. Preferably the control device uses the signal from the Lambda sensor as a steering value and tries to hold the Lambda value at 1.0 by changing the air/fuel ratio. Due to the efficient combustion process according to the present invention, it is possible to obtain and hold a Lambda value of 1. In a fuel injection system the control device 510 controls the amount of fuel injected and thus the air/fuel mixture ratio in the combustion chamber.

When running the engine according to the present invention it is in its basic design run on gas. Running it on other fuels may demand a change in mechanical design and electronic steering of the engine in order to run the engine more optimally. For instance liquid fuel need to be finely spread in order to have better mixing between fuel and air, in an fuel injection engine at the end of the injection process, a small amount of air may be entered after the fuel in order to clear fuel injection inlets from fuel, fuel/air ratios may be changed depending on fuel efficiency, and ignition timings may be changed.

Different types of fuels can be used according to the present invention, such as, but not limited to, petrol (gasoline), alcohol (e.g. Methanol or Ethanol), LPG (Liquid Propane Gas), natural gas, different forms of bio gases (possibly in refined form), and city gas. Depending on fuel other fuel injection systems may be required. Timing between fuel injection and crank shaft angle may be utilized, i.e. fuel injection timing is controlled with respect to crank shaft angle.

Due to the late ignition (ca 20 ATDC) timing and higher compression ratios, locally higher temperatures may be obtained as compared to conventional engines. In order to function properly, spark plugs withstanding high temperatures (e.g. made of special materials and/or cooled) are used and the ignition voltage is higher than 30 kV, preferably 40 kV. Too low voltage will result in misfiring or back firing but the system may be used from 25 kV. The increased voltages require stronger ignition coil and suitably arranged ignition systems to handle the higher voltages. It may also be of interest to use an ignition system with lower impedance than conventional ignition systems, in the order of a few ohms or below. Due to the high compression ratio and risk of increased temperatures care need to be taken to reduce any sharp edges present on the spark plug, for instance there should not be any visible threads inside the combustion chamber 11 between the spark plug inlet of the combustion chamber 11 and the actual spark generating part of the spark plug. The voltage is illustrated for a standard spark plug solution with one spark arc. However, for other spark plug designs other voltages apply since it really is the energy release that is of importance, for instance a spark plug with several spark arcs may have a smaller voltage but release the same energy in the combustion chamber.

By having high voltages and high compression, the combustion process is rapid which is important since then chemical energy is converted into kinetic energy of the piston 2 instead of generating heat within the combustion chamber 11 and the surrounding material.

Sharp edges may become hot enough for spontaneous ignition to occur from these hot spots. However, due to the rapid combustion provided by the high pressure in a small combustion chamber, the overall heat transfer to the surrounding walls is lowered leading to a lower exhaust temperature.

This demand for removal of sharp edges applies to substantially all parts within the combustion chamber 11. For instance the piston 2 needs to have a rounded circumferential edge 12. The radius of this edge should be in the range of 0.5 mm or larger, preferably approximately 2 mm.

In order to even further reduce any adverse effects in the combustion chamber a cavity in the piston may be formed. This cavity has at least two positive effects with respect to reduce the impact from the combustion on the inner walls of the combustion chamber:
1. Since a large part of the combustion will take part within this cavity the heat exposure on the inner walls of the combustion chamber 11, i.e. the lining 13 of the cylinder, will be reduced considerably (at least during the start phase of the combustion process).
2. One may argue that the energy released during the combustion process will be deposited on a larger surface area (the cavity increases the surface area of the piston), the temperature increase will be reduced accordingly.

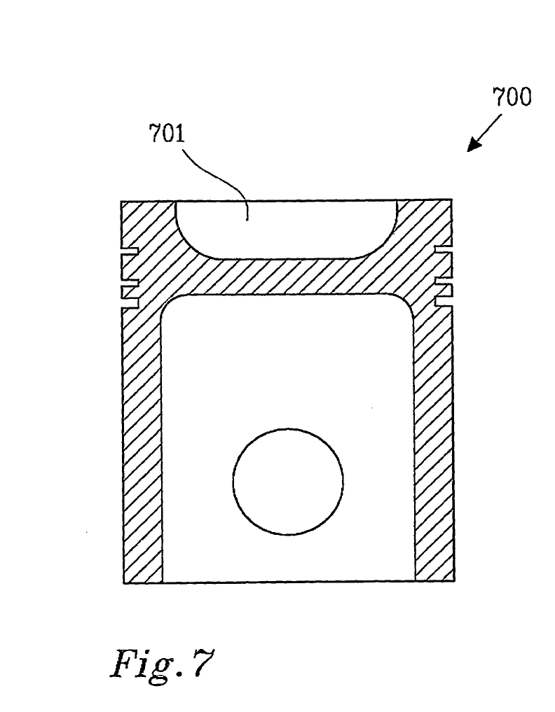

FIG. 7 illustrates a piston 700 according to the present invention in a cross section of the piston 700, wherein a cavity 701 is formed in the top part of the piston 700. The form of cavity is not limited to the exemplified, but may have many different forms with different aspect ratios between depth and width, different shapes, and different numbers as understood by the person skilled in the art. As the combustion process evolves, the flame front initially starts within this cavity 701, possibly as a substantially spherical ball of flame front, and exerts a substantial part of the pressure and heat effect on the inner part of the cavity 701 and a smaller part on the lining of the cylinder. The piston 700 is more easily cooled than the top part of the cylinder lining and therefore a quicker cooling is obtained. It should be understood that a similar cavity may also be formed in the “roof” of the cylinder instead of the piston or together with the cavity in the piston.

The height between the top of the piston and the “roof” of the cylinder when the piston is at its top dead center position, i.e. the so called squish height, is also of importance: a small squish further enhances the burn rate during the combustion process and a rapid combustion process is advantageous for the invention. However, a larger squish height reduces the risk of hot spots within the combustion chamber. The squish may advantageously be at least 0.7 mm or higher. The squish is measured from a top point of the piston and not from any cavity portion mentioned in relation to FIG. 7.

An important factor in the present invention is the burn rate and the configuration of the engine aim towards a rapid burn rate which can be defined as when 90% of the fuel has been used in the burn process as a function of crank angle position in degrees. In the present invention an overall burning angle, from 0 to 90% burned fuel/air mixture is of the order of 15-40 crank angle degrees depending on the revolutions, fuel, and/or type of the engine. The peak of the burn process may vary depending on when the igniting device starts the burn process.

It is of importance the way the timing of the valves is set up. There should preferably not be any overlapping of open valves between the inlet 4 and outlet 5 of the cylinder, i.e. if the inlet valve 4 is open the outlet valve 5 should be closed and vice versa. Also in order to efficiently remove exhaust after the combustion process, the outlet valve 5 should not be throttled; rather the engine should be able to “breathe freely” in order to quickly remove exhausts from the combustion chamber 11. However, in some circumstances some overlap between valve openings may be present.

In one embodiment of the engine, a gas engine converted from a diesel engine, according to the present invention is preferable run without a turbo since this would demand a controlled steering of the engine due to the high temperatures of the combustion process; however, if running the engine turbo charged, the turbo should be set at a maximum turbo pressure of 0.8 bars, and preferably 0.4 bars for optimal performance; however, other turbo pressure settings may be applied. It is of interest to not have any valve overlap in order to not increase the temperature in the combustion chamber 11.

Some of the advantageous of the present invention as compared to conventional engines are:
Higher efficiency.
higher output power.
Less contamination of the combustion chamber from unwanted products.
Less wear on engine details.
Higher torque output
Runs more silently.
Reduced number of service occasions, i.e. longer service intervals.
Reduced fuel consumption.
Reduced outlet of environmentally damaging exhausts.
2 way catalytic converter. The engine may be run with a 2-way catalytic converter; however, the catalytic process may be more efficient with a 3-way converter.
Less vibrations.
Lower exhaust temperature.

The crank shaft is in a favorable position, already past the top dead center, when the combustion process starts, thus decreasing the mechanical stresses on the components. This effect lead to several of the above mentioned advantages.

The engine according to the present invention has an advantage that it reaches full or nearly full torque at low revolutions of the engine (e.g. 1300 RPM, revolutions per minute) and thereafter has a substantially static torque curve up to the maximum available revolutions.

It is possible to run the engine in a lean mode, i.e. a surplus of oxygen as compared to the stoichiometric air/fuel ratio (14.7:1) meaning a lambda value larger than 1.0. However, running the engine in this mode requires some changes of the engine configuration, such as for the fuel/air mixing device, the timing of the ignition point with respect to the crank shaft angle, and so on.

Different valve timing settings may be utilized depending on the engine configuration, fuel, and running mode. For instance the invention may benefit from a delayed closing of the inlet valve in order to obtain a reduced amount of energy for compression (compare the Miller cycle sometimes used for diesel engines) and homogenizing of combustion mixture: part of the combustion mixture that has entered the combustion chamber may exit back into an upstream volume of the combustion mixture canal prior to the inlet valve. This homogenized combustion mixture will then positively affect combustion mixture volumes in transport to the inlet valve for the next burn cycle. The inlet valve is thus arranged to be open during a portion of the compression cycle; at least 10% of the compression stage. For instance in one embodiment of the present invention the inlet valve closes at 135° before the top dead center. The homogenizing of the combustion mixture will facilitate the burn process leading to a more rapid burn rate; this may for instance be a benefit in systems using liquid based fuels, e.g. petrol, i.e. liquid at normal temperatures and pressures.

Due to the reduced wear on the components of the engine according to the present invention, in particular to the force transmitting components, it is possible to have other timing orders of the cylinders than for a conventional engine. For instance a six cylinder engine in a conventional engine often has timing order of cylinder 1, 5, 3, 6, 2, and 4, whereas in the present invention other orders are possible, for instance, but not limited to, 1, 2, 3, 4, 5, and 6.

The present invention is not limited to the specific exemplified air/fuel mixer 502 and throttle 505 solution but any other type as understood by the person skilled in the art may be utilized, such as carburetor based systems or fuel injection systems, including common rail solutions. In common solutions for petrol driven engines, a preferred operating pressure may be approximately 200 bar, but care need to be taken to not inject fuel/air mixture into the combustion chamber close to full compression. Rather it is preferred to inject the fuel well before the top dead center, in the range −270 to −90 degrees BTDC (before top dead center). Preferably, an individually controlled injection is provided for each cylinder and that the fuel is mixed with air before entering into the combustion chamber. In such an individually controlled system it is of interest to control the combustion process with the measured Lambda value as a feedback parameter.

As mentioned, it is possible to use direct fuel injection with the engine; however fuel delivery components and air/fuel mixing methods change accordingly, as understood by the person skilled in the art. This applies to other fuel delivery systems as well of course.

It should be understood by the person skilled in the art that sensors 507 may be preconditioned using external components and/or directed to the control device 510 (600), using a common communication link system often available in vehicles for instance, instead of direct linkage to the control device 510.

The engine according to the present invention as described above may be used in any type of vehicle, including but not limited to, cars, motorcycles, trucks, fork lifts, buses, and other heavy commercial vehicles. The engine may also be used in vessels, e.g. ships, chain saws, power generating equipment for driving different types of mechanical operations, in electricity generating devices for instance in a power station, or in any other type of object including a spark ignited (SI) engine.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, and that several “means” may be represented by the same item of hardware.

The above mentioned and described embodiments are only given as examples and should not be limiting to the present invention. Other solutions, uses, objectives, and functions within the scope of the invention as claimed in the below described patent claims should be apparent for the person skilled in the art.

1. An internal combustion engine of piston type operating with a mixture of combustible fuel and air comprising:
at least one combustion chamber and a piston movably arranged in said combustion chamber to compress the fuel and air mixture so as to provide a maximum compression ratio in the range of 15:1 to 25:1;
an inlet arranged in said combustion chamber for receiving an amount of said mixture of fuel and air into said combustion chamber;
an igniting device arranged in said combustion chamber for igniting said mixture of fuel and air received in said combustion chamber at a crank shaft angle position in the range of 0 degrees to 15 degrees after a top dead center (ATDC) of said piston in said combustion chamber; and
wherein the combustion chamber and piston is arranged to reduce the risk of hot spots and the engine is configured to have a burn rate where 90% of the fuel is burnt in a crank angle position range of between 15° to 40°.

2. The combustion engine according to claim 1, wherein said compression ratio is preferably in a range between 17:1 to 20:1, and even more preferably between 17.5:1 to 18.5:1.

3. The combustion engine according to claim 1, wherein said crank shaft angle is preferably in a range between 0° and 5°, and most preferably 2° after said top dead center (ATDC).

4. The combustion engine according to claim 1, wherein edges within the combustion chamber is rounded with a radius of at least 2 mm.

5. The combustion engine according to claim 1, wherein edges within the combustion chamber is rounded with a radius of at least 0.5 mm.

6. The combustion engine according to claim 1, wherein said piston comprises at least one cavity on a top portion of said piston.

7. The combustion engine according to claim 1, wherein said ignition device comprise a spark plug comprising a substantially smooth surface between a spark plug inlet in said combustion chamber and a spark generating unit on said spark plug.

8. The combustion engine according to claim 1, wherein edges on a portion of said piston facing said ignition device are rounded with a radius of at least 0.5 mm.

9. The combustion engine according to claim 1, wherein edges on a portion of said piston facing said ignition device are rounded with a radius of approximately 2 mm.

10. The combustion engine according to claim 1, further comprising a control device with means for controlling a ratio of said fuel and air mixture.

11. The combustion engine according to claim 10, further comprising an oxygen sensor, for instance a Lambda sensor, located after said combustion chamber in an exhaust outlet conduit.

12. The combustion engine according to claim 11, wherein said control device read a signal from said oxygen sensor and said signal is used for determining said ratio of air to fuel mixture.

13. The combustion engine according to claim 12, wherein said control device control a position of an adjustable air to fuel ratio controlling element.

14. The combustion engine according to claim 12, wherein said control device is arranged to hold a Lambda value at approximately 1.

15. The combustion engine according to claim 1, wherein said crank shaft angle ignition position is kept fixed during operation of said engine.

16. The combustion engine according to claim 1, wherein said crank shaft angle is adjustable between 10 degrees ATDC to 0 degrees ATDC depending on power output and/or revolutions.

17. The combustion engine according to claim 1, wherein the igniting device is arranged to provide a spark from an ignition voltage of at least 25 kV.

18. The combustion engine according to claim 1, wherein the igniting device comprise a spark plug operating at a voltage preferably in excess of 30 kV.

19. The combustion engine according to claim 1, further comprising a turbo providing a maximum turbo pressure of 0.8 bars, and preferably 0.4 bars.

20. The combustion engine according to claim 1, wherein said fuel is at least one of petrol (gasoline), alcohol (e.g. Methanol or Ethanol), LPG (Liquid Propane Gas), natural gas, bio gas, and city gas.

21. The combustion engine according to claim 1, further comprising means for controlling the ignition with respect to crank shaft angle.

22. The combustion engine according to claim 1, wherein a squish height is at least 0.7 mm.

23. The combustion engine according to claim 1, wherein the inlet is arranged to be open during at least 10% of the compression stage.

24. The combustion engine according to claim 1, further comprising a mixing device for mixing air and fuel comprising:
a venturi device;
an air inlet; and
a fuel inlet structure;
wherein a position of a valve in said mixing device is adjustable and providing an adjustment of a ratio of said air/fuel mixture.

25. A method of combustion in a combustion engine, comprising the steps of:
providing a combustion engine comprising a combustion chamber with a piston, the chamber and piston both arranged to reduce hot spots;
configuring the combustion engine so as to provide a high burn rate where 90% of the fuel has burnt within a crank angle position range of 15° to 40°.
providing an air/fuel mixture to the combustion chamber through an inlet;
closing the inlet during a compression stage; and
igniting said air/fuel mixture when a maximum compression ratio of said air/fuel mixture is in a range of 15:1 to 25:1 and when a crank angle position of a piston is in a range of 0 degrees to 15 degrees after a top dead center (ATDC).

26. The method of controlling a combustion according to claim 25, wherein said compression ratio is preferably in a range between 17:1 to 20:1, and even more preferably between 17.5:1 to 18.5:1.

27. The method of controlling a combustion according to claim 5, wherein said crank angle position is preferably in a range between 0° and 5°, and most preferably 2° after said top dead center (ATDC).

28. The method according to claim 25, wherein substantially all edges inside a combustion chamber are provided with a radius of at least 0.5 mm including a piston with at least one cavity on a top portion of said piston

29. The method according to claim 28, wherein said radius of edges are approximately 2 mm.

30. The method according to claim 25, wherein the ignition is provided by a spark generated by a voltage in excess of 25 kV

31. The method according to claim 25, further comprising:
obtaining a signal of an oxygen value after said combustion chamber;
feeding said signal to a control device; and
controlling a ratio of said air/fuel mixture provided to said combustion chamber using said signal as control value.

32. The method according to claim 31 wherein said control device keeps said oxygen value to approximately Lambda=1.

33. A vehicle comprising an internal combustion engine according to claim 1.

34. A ship comprising an internal combustion engine according to claim 1.

35. A power station comprising an internal combustion engine according to claim 1.
